(19) United States
(12) Patent Application Publication
(10) Pub. No.: US 2009/0137222 A1
(43) Pub. Date: May 28, 2009

(54) LOCATION-BASED ALERT SYSTEM

(76) Inventor: Kjell-Harald HEEN, Oslo (NO)

Correspondence Address: BIRCH STEWART KOLASCH & BIRCH, PO BOX 747, FALLS CHURCH, VA, 22040-0747, US

(21) Appl. No.: 12/259,116

(22) Filed: Oct. 27, 2008

Related U.S. Application Data
(60) Provisional application No. 60/990,308, filed on Nov. 27, 2007.

(51) Int. Cl. H04M 11/04

(52) U.S. Cl. 455/404.1

(57) ABSTRACT

Method and system for sending alert messages to users of mobile phones staying at a specific geographical location without overloading the network, and doing so independently of any user preferences.

### TECHNICAL FIELD

The present invention relates to a population alert system for sending alert messages to users staying at a specific geographical location. More specifically, the invention describes a method and a system for efficiently locating and sending messages to mobile phones located within a specific area, without overloading the network, and independent of any user preferences.

### BACKGROUND OF THE INVENTION

Today people are exposed to more threats than for just a few decades ago, and at the same time efficient existing methods for warning people are based on old technology used for warning of war related scenarios like bomb and missile attack. This is not considered to be usable for methodical alert for emergency situations related to:
More unpredictable weather conditions due to climatic changes;
Increased transportation through dense populated areas;
Industry located close to populated areas;
Infrastructure breakdown, and
Increased risk for terrorism.

New and efficient methods for warning and protecting people is therefore a highly focused area within the EU and US, but also in Asian countries which are often exposed to natural disasters like tsunamis and earthquakes. Billions of Euros have been spent in developing systems and methods to detect and predict in advance different kinds of natural and man made hazards (e.g. Global Monitoring Environmental Security (GMES) program). A predictive monitoring system has less or no value if it is not capable of alerting people exposed to the danger. Finding new and more efficient methods for alerting people is therefore a highly focused topic.

A complete population alert system must make use of multiple channels for distribution of alert messages, but the capability to alert mobile users is regarded to be the most important and critical feature.

Secure and efficient alert of mobile users has up to date been a problem that has not been sufficiently solved with regard to overload and efficiency aspects. Systems as described in prior art and with some similarity to the present invention suffer from being ineffective and vulnerable due to the fact that alert messages have to go through the existing structure and devices in the mobile network in the same way as other calls, thereby exposing the system for overload when sending a lot of alert messages at the same time.

In the following, features contributing to secure and efficient alerting, as solved by the present invention is listed:
Localization of people within a certain area nationally (including visitors from other countries), and without a specific kind of subscription, and without any kind of personal settings or application needed on the mobile device;
Localization of national citizens travelling abroad and without any kind of subscription, and without any kind of personal settings or application needed on the mobile device;
Global coverage, i.e. able to detect national citizens in any country;
Avoid overload and congestion of the network during emergency situations when sending large amount of alert messages simultaneously, and
Optimized for fast and network friendly distribution of SMS (Short Message Service).

### BRIEF DESCRIPTION OF THE INVENTION

The present invention is described by a method for locating and alerting a plurality of mobile phone users located in a specific geographical area, and doing so independently of any user preferences, by sending alert messages to relevant mobile phones. The method is optimized for avoiding overload and congestion of the network, and is performed in an optimizing message distribution component (MDC) connected to the mobile network, and where the method comprises the following steps:

a) receiving an alert initiation message comprising information about the content of the message and where it is to be sent, represented as relevant cells;

b) receiving updated information of mobile station ISDNs (MSISDN) number with current serving cells on base station system (BSS) level;

c) assessing received information and determine the relevant mobile phones with corresponding MSISDN numbers to send alert messages to, and

d) sending the alert messages from the MDC through a base station controller (BSC) to relevant mobile phones located in the specific geographical area.

The invention is also characterized by a system for performing the method described above.

The method and the system are described in more detail in the appended set of claims.

### DETAILED DESCRIPTION OF THE INVENTION

The object of the present invention which is a location based alert service (LBAS) is to enable a secure and efficient way of alerting mobile users within a geographical area.

The present invention will now be described in more detail with reference to the figures wherein:

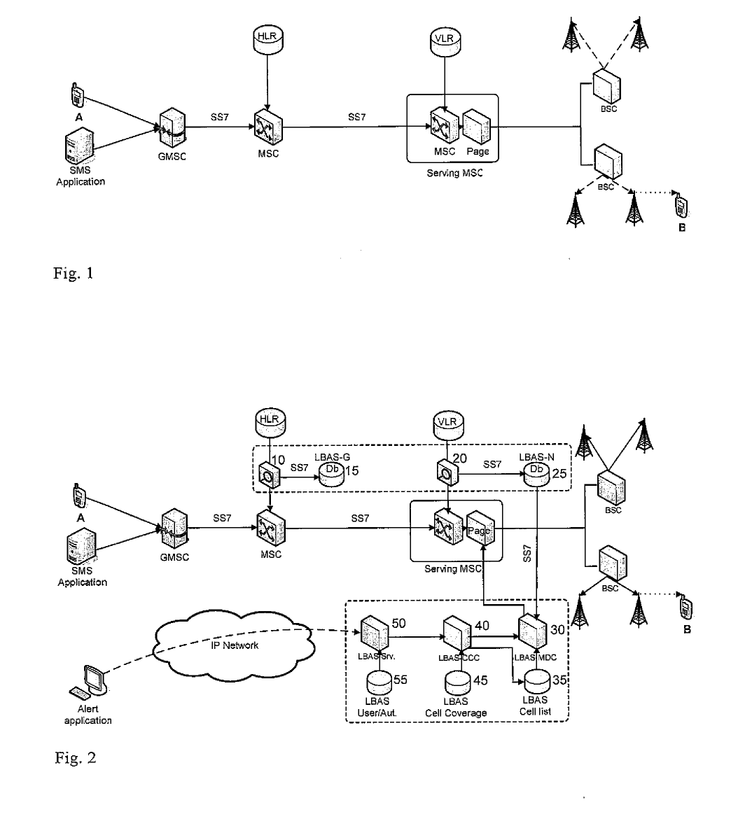

FIG. 1 shows a general architecture of the system involved when a mobile phone “A” is making a call to a mobile phone “B”;

FIG. 2 shows the architecture of LBAS compared to the architecture of traditional distribution of SMS;

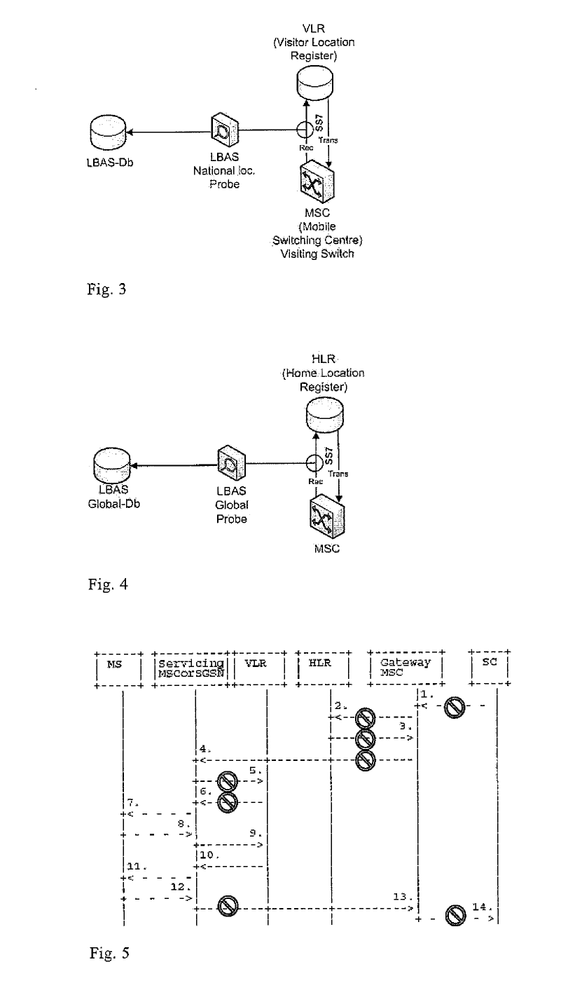

FIG. 3 shows a probe monitoring the traffic from the MSC to the VLR;

FIG. 4 shows a probe monitoring the traffic from the MSC to the HLR;

FIG. 5 shows the standard SMS send procedure in detail, and

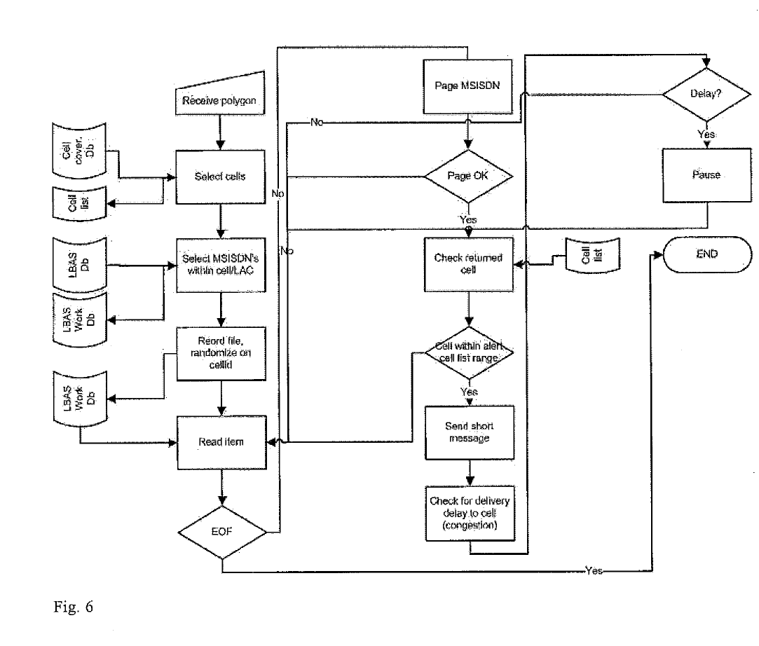

FIG. 6 shows the optimized work flow of message distribution performed by a message distribution component.

FIG. 1 shows a general architecture of the system involved when a mobile phone marked as “A” is making a call to another mobile phone marked as “B”. This figure visualizes the complexity of the network, and why special considerations are needed when using the mobile infrastructure as the channel for distribution of alert messages.

Before a phone connection or a distribution of a message between two mobile phones can take place, a rather complex and resource consuming process is performed in order to be able to identify the location of the mobile phone to receive the call.

The following steps will be performed when “A” is making a call to “B”:
1. “A” is connected to the closest Gateway Mobile Switching Center (GMSC) which identifies the Switch and Home Location Register (HLR) which “B” belongs to;
2. A connection to the HLR is performed to find fundamental information of “B”, in particular to identify the switch that “B” was last reporting to;
3. A connection to the identified switch is performed;
4. A look up in the Visitor Location Register (VLR) is performed to verify if “B” is still connected to the identified switch, and if so a more exact position of “B” is identified through the Local Area Code (LAC);
5. A paging process (explained below) is initiated. All the Base Station Controllers (BSC) within the local area of “B” is asked to page the mobile of “B” over all the cells in the local area.
6. If “B” responds (i.e. is detected within a cell), and if there is a free channel, a channel allocation is taking place and “B” is ready to receive the message.

GMSC is the switching centre that all mobile to mobile calls are routed through.

HLR is a global database that resides within a cellular network to hold current details about a subscriber, the equipment in use, the service(s) required, the user's identification encryption code, and the users “Home” cell, and what network the subscriber was last known to be using.

VLR is a database similar to HLR, but with storing of national location data.

LAC is the local area code indicating a current geographical area.

BTS—Base Transceiver Stations is the heart of a cellular mobile phone system, and is a network of distributed transmitting/receiving radios in fixed locations.

BSC is used to control groups of BTSs, provide mobility management for mobile stations, anchor air-link protocols and provide connection to a mobile switching centre (MSC). The composite collection of one or more BTS and the associated BSC will form a base station system (BSS).

Paging is one of the key elements which make mobile telephony possible. It is a critical process, both with regard to correct localization and optimizing of radio network traffic, i.e. what is actually paging and how it is working.

In order to be able to establish a voice call or sending a SMS, it is necessary to know to which radio cell the mobile device is connected to. The VLR has an approximate knowledge of where the mobile device is located. In the VLR, the mobile device is located on the local area level (LAC). A local area will vary from place to place and operator to operator, but it is common that a LAC may contain hundreds of cells. Since the VLR knows which LAC the receiving mobile device is located within it will need to search for the mobile device within the LAC to get the exact cell. This is where the paging process is starting. Briefly explained it works as follows:
Paging is performed by the serving MSC which is responsible to deliver the message;
The MSC is ordering all the BTSs within the LAC to perform a page. A mobile id (IMSI—International mobile subscriber identifier is a GSM term used to uniquely identify a subscriber to a specific carrier and country) is sent over the air via a particular paging channel;
The mobile device recognizing the id will respond to the page with a cell id;
The cell id is received at the MSC and the location of the mobile device is identified;
The MSC is now ready to transmit the message.

As seen from FIG. 1, call or message routing is a complex process designed for communication between two mobile devices. With huge load, like automated mass broadcast of messages and careless use of the network, there are several places within the message routing process that can be overloaded and congested. Heavy load on both the HLR and VLR can cause serious problems breaking down the mobile “network subsystem”. Large paging activities are also a vulnerable signalling activity which can cause congestion and overload of the “Base station subsystem”. These aspects have motivated the creation of the present invention.

FIG. 2 shows the architecture of LBAS compared to the architecture of traditional distribution of SMS. This figure illustrates how the LBAS system can optimize and reduce the routing process, and thereby avoiding overload of the network when sending a large amount of messages simultaneously. The LBAS specific environment is shown within frames with broken lines.

The difference from ordinary call/message routing is the extended information LBAS has about the recipients of the message. Having in mind that the LBAS database, which is described below, is containing the current coverage cell, i.e. the geographical location of each mobile handset belonging or roaming to the mobile operator there is no need to connect to the HLR to find the last reported switch of the called party, or to connect to the VLR to find the location area of the called party. Further there is no need to page all cells within a local area which may be hundreds. It is only necessary to page the cells covering the actual area to alert.

Since the above mentioned procedure for sending a message from one mobile phone “A” to another “B” is technically resource consuming, and in this case unnecessary, the LBAS will address the distribution of alert messages in a more direct and efficient way over the SS7 mobile phone network (SS7 is the set of telephony signalling protocols used for setting up public switched telephone network calls) thus avoiding the above mentioned vulnerable operations.

The present LBAS invention is divided into the following major components as shown in FIG. 2:
1. Storing of real time national user/location data into LBAS National database 25, containing local area and cell coverage for each national mobile user and visitor (foreign tourists) to the network. This database is the source for the optimizing message routing component (MDC);
2. Storing of real time global user/location data into the LBAS Global database 15, containing country and part of country (thus the MSC) that the national mobile users are roaming to abroad. This function has global coverage, and
3. Optimized message routing (by means of MDC 30), enabling a more efficient and network friendly way of routing alert text messages in the mobile network.

Probes 10, 20 are located between HLR and VLR and corresponding MSCs for monitoring traffic and updating the LBAS Databases 15, 25. Said MDC 30 will only read and process data from the VLR providing information concerning national location data, since in the case of global alerting, an alert message may be terminated with an unknown operator.

A probe is a component designed to monitor the traffic between two components within a network without interfering the traffic. In this case the traffic between the MSC and said HLR and VLR databases. A probe comprises a computer with signalling means connecting to the network for monitoring traffic. LBAS software for storing location traffic in a relation database (LBAS Db) is a part of the probe software.

An LBAS Web service 50, 55 will work as an interface between the alert application/protocol and LBAS core environment. This is not a part of the LBAS core but is shown for visualizing how LBAS is made accessible to external systems. LBAS Web Service will provide LBAS functionality to the end user application and handle secure authorization of LBAS users.

After the alert is authorized by the LBAS Service, the first operation taking place is the localization of the cells covering the relevant area. This is performed by the CCC (Cell Coverage Component) 40, 45. The result with information on cells covering the relevant area is written to the Cell list Db 35.

The MDC 30 is a key component of LBAS, performing both identification of the mobile devices, and thus the people within the affected area by selecting from the LBAS National Db 25 only items with a cell id matching cell ids from the generated cell list, and optimized transmission of the short messages.

FIG. 3 shows a probe monitoring the traffic from the MSC to the VLR thereby enabling storing of national location data. The probe which is an ss7 component is installed in the operator's network subsystem. Traffic identified as location information is absorbed and updated in the LBAS National Database containing real time location data of all subscribers and roaming visitors within the network.

The method for storing national location data is as follows:

The probe is monitoring traffic received by the VLR. Traffic related to location updates delivered to the VLR is identified and stored in the LBAS national Db. Amongst the MAP (Mobile Application Part) messages identified and containing location data are e.g. MAP_UPDATE_LOCATION AREA (reporting entrance of a new LAC) and MAP_PROCESS_ACCESS_REQUEST_ACK (response of page of mobile devices which occurs when sending and receiving messages and phone calls). These messages are containing both LAC and Cell Id.

The record inserted or updated in LBAS Db is containing: IMSI (International Mobile Subscriber Identity) or MSISDN, Cell Id, Lac Id, date and time.

FIG. 4 shows a probe monitoring the traffic from the MSC to the HLR enabling storing of global location data. The probe is installed in the operator's network subsystem enabling storing of real time location data of all national mobile users abroad.

The method for storing of global location data is as follows:

The probe is only monitoring traffic received by the HLR. When a mobile device arrives at a new country or is travelling over some distance within the country, it will enter the coverage of a new MSC. The VLR of the serving MSC abroad will ask the subscribers HLR for some vital customer information. At the same time it will send location information regarding which MSC the mobile device currently is served by (MAP_UPDATE_LOCATION) to the HLR at home, this message is then identified and an update of the LBAS Global Db is performed.

The monitored data comprise: IMSI (International Mobile Subscriber Identity), MSC, Country/part of country, date and time.

Global location data is not as exact as national location data since the accuracy is limited to MSC level.

FIG. 5 shows the standard SMS send procedure together with the steps that are skipped by using LBAS according to the present invention for optimizing the message distribution.

As is apparent from this figure, routing of a message or call is a complex procedure with several vulnerable components. Due to the fact that LBAS both know which cells that are going to be alerted and which phones that are connected to the different cells, all necessary parameters is in place to avoid the resource consuming routing and localization process, thus reducing the load of the operator's “Network Subsystem”. Another aspect is the load on the “Base Station Subsystem”. Since we know which cells that are covering the area, we only want to perform a paging procedure for mobile devices still connected to these cells thus reducing the load on the “Base Station Subsystem”.

The different steps of the process are as follows:
Steps 1-3 are the routing phase which is described above with reference to FIG. 1. These steps are not performed in LBAS;
Step 4 is the forwarding of the SMS from the gateway MSC to the servicing MSC. This step is not performed in LBAS because the message is sent from the MDC which is directly connected to the serving MSC;
Step 5 is performed for retrieving subscriber related data. This step may or may not be performed;
Steps 6-10 are the paging process. This process is performed but is proposed optimized by only paging relevant cells within the alert area, instead of all the cells within the LAC;
Steps 11-12 are sending of the SMS and confirmation to the servicing MSC, and
Steps 13-14 are acknowledgement of the message sent and forwarded to the gateway MSC. This step is not performed in LBAS.

FIG. 6 shows the modified and optimized work flow of message distribution for locating and alerting a plurality of mobile phone users located in a specific geographical area, and doing so independently of any user preferences, by sending alert messages to relevant mobile phones, and where the method is optimized for avoiding overload and congestion of the network. The method is performed in the optimizing message distribution component (MDC) connected to the mobile network. The method comprises the following steps:

a) receiving an alert initiation message comprising information about the content of the message and where it is to be sent, represented as relevant cells,

b) receiving updated information of mobile station ISDN (MSISDN) numbers with current serving cells on base station system (BSS) level,

c) assessing received information and determine the relevant mobile phones with corresponding MSISDN number to send alert messages to, and

d) sending the alert messages from the MDC through a serving MSC to relevant mobile phones located in the specific geographical area.

In one embodiment, the MDC is further connected to a CCC (Cell Coverage Component) with information about the geographical area where the alert messages are to be sent. The CCC receives this information as a request from a LBAS Service requesting initiation of alerting of mobile phones in a specific geographical area represented by different cells. The request may comprise a polygon containing the coordinates of the area to alert.

The LBAS Service is connected to an interface for managing and controlling the method, and the interface is used for selecting type of alert message and the geographical area to where the messages are to be sent.

The CCC will convert the specific geographical area to corresponding cell ids that are located inside the specific area. This is performed by looking up entries in a database cell list, and a cell coverage Db, thus acquiring information on which geographical area each cell is covering, and screening only cells that are located in the relevant geographical area before this information is sent to the MDC. These cell ids are the input to step a) above together with to content of the message.

The MDC is further connected to a location based alert system database (LBAS Db) with updated information of MSISDN numbers, thus the mobile phones, together with the ids of the serving cells that they are connected to. The LBAS Db is kept updated by using a probe explained above (ref. FIG. 3).

The information from the LBAS Db is acquired by the MDC and is the input in step b) above.

After the steps described above, the MDC has received the content of the message to send, cell ids defining the geographical destination area of the alert message, and the relevant MSISDN numbers with connected cell ids in the geographical destination area.

This information is preferably stored as a temporary table in a LBAS working database, i.e. MSISDN number, cell id, and message, used when randomizing the cell ids before performing the paging step described below in order to reduce queued traffic load on the same cell.

The MDC then performs a paging procedure on each randomized MSISDN number in the LBAS working database for receiving ids of present serving cells for each relevant MSISDN numbers, and checking whether the returned cell ids still are within the range of the cells covering the relevant geographical area. The paging procedure itself is performed in a module comprised in the serving MSC, but it is initiated by the MDC.

This corresponds to assessing step c) above.

The MDC is further connected to a base station controller (BSC) for controlling cells represented by groups of base transceiver stations (BTS) located at fixed geographical locations ensuring mobility management for mobile stations.

If the paging procedure described above is affirmed, the alert message is sent from the MDC through said serving MSC to all the relevant mobile phones located in the specific geographical area.

In this process, the MDC measures the time elapsed from sending an alert message to an MSISDN number through its connected cell to receiving a confirmation from that cell, and if the time elapsed is above a certain limit, the MDC will reduce the load of the current cell by sending the next alert message through another cell.

The paging procedure described above is performed on all entries in the LBAS working database until the end of the file in the randomized working LBAS database has been reached.

The present invention also comprises a system for performing the method described above. Such a system may comprise different components with the main purpose of being able to perform the inventive method. The main system claim describes the components comprised in the system with further implementations as described in accompanying dependent claims.

The components of LBAS can easily be installed in the mobile operator's environment without interfering with the existing core infrastructure. The use of LBAS functionality must however be highly secured both with regard to misuse and privacy. Only certain certified systems/application, e.g. PAS, will be certified to integrate to LBAS. Users can for instance be emergency authorities in any country. Europe and other well developed areas like the US has so far been the main target for high tech mobile technology. However due to rapid spreading of the mobile technology, combined with natural and climatic threats in for instance south Asian countries and also the fact that many of these countries are popular tourist targets, makes LBAS as an ideal system for alerting and protecting both inhabitants and tourists in the region.

For a person of skill in the art it is obvious that there are many different ways of implementing such a system. The actual invention is set forth in the independent main claims. A specific implementation that can be seen from the description above is intended to be as an example of how the LBAS system can be implemented.

1. A method for locating and alerting a plurality of mobile phone users located in a specific geographical area, and doing so independently of any user preferences, by sending alert messages to relevant mobile phones, and where the method is optimized for avoiding overload and congestion of the network,
characterized in that the method is performed in an optimizing message distribution component (MDC) (30) connected to the mobile network, and where the method comprises the following steps:
a) receiving an alert initiation message comprising information about the content of the message and where it is to be sent, represented as relevant cells,
b) receiving updated information of mobile station ISDN (MSISDN) numbers with current serving cells on base station system (BSS) level,
c) assessing received information and determine the relevant mobile phones with corresponding MSISDN number to send alert messages to, and
d) sending the alert messages from the MDC (30) through a serving MSC to relevant mobile phones located in the specific geographical area.

2. A method according to claim 1, characterised in that the MDC (30) is connected to:
a cell coverage component (CCC) (40) with information about geographical area where the alert messages are to be sent,
a location based alert system database (LBAS Db) (25) with updated information of MSISDN number with current serving cell, and
a serving MSC for controlling cells represented by groups of base transceiver stations (BTS) located at fixed geographical locations providing mobility management for mobile stations, and where:
1) the alert initiation message received in step a) is performed as a request from the CCC (40) to the MDC (30), and information about the relevant cells is determined by the CCC (40) by converting information of a specific geographical area to corresponding cell ids;
2) the received updated information in step b) is acquired by looking up entries in the LBAS Db (25) with updated information of MSISDN numbers of the mobile phones connected to the relevant cells, represented by cell ids within the specific requested geographical area;
3) the assessing of received information in step c) includes to perform a paging procedure on relevant MSISDNs for receiving ids of present serving cells for each relevant MSISDN, and checking whether the returned cell ids are within the range of the cells covering the relevant geographical area.

3. A method according to claim 2, characterised in that the CCC (40) is connected to a LBAS Service (50) that is connected to an interface for managing and controlling the method, and where the interface is used for selecting type of alert message and the geographical area to where the messages are to be sent.

4. A method according to claim 2, characterised in that the CCC (40) converts information of a specific geographical area to cell ids, by reading a database list with information on which area each cell is covering, and screening only cells that are located in the relevant geographical area before this information is sent to the MDC (30).

5. A method according to claim 2, characterised in that LBAS db (25) is dynamically updated with information received from a probe (20) monitoring the traffic between a mobile switch centre (MSC) and a visitor location register (VLR) residing within the network holding current details about subscribers and equipment used.

6. A method according to claim 2, characterised in that the cell id results are stored in a temporary table used for randomizing the cell ids before the paging step 3) in order to reduce queued traffic load on the same cell.

7. A method according to claim 1, characterised in that the MDC (30) measures the time elapsed from sending an alert message to an MSISDN number through its connected cell to receiving a confirmation from the cell, and if the time elapsed is above a certain limit, the MDC (30) will reduce the load of the current cell by sending the next alert message through another cell.

8. A system for locating and alerting a plurality of mobile phone users located in a specific geographical area, and doing so independently of any user preferences, by sending alert messages to relevant mobile phones, and where the system is optimized for avoiding overload and congestion of the network,
characterized in that the system comprises an optimizing message distribution component (MDC) (30) connected to the mobile network, and with means for:
a) receiving an alert initiation message comprising information about the content of the message and where it is to be sent, represented as relevant cells,
b) receiving updated information of mobile station ISDN (MSISDN) numbers with current serving cells on base station system (BSS) level,
c) assessing received information and determine the relevant mobile phones with corresponding MSISDN number to send alert messages to, and
d) sending the alert messages from the MDC (30) through a serving MSC to relevant mobile phones located in the specific geographical area.

9. A system according to claim 8, characterised in that the MDC (30) is connected to:
a cell coverage component (CCC) (40) with information about geographical area where the alert messages are to be sent,
a location based alert system database (LBAS Db) (25) with updated information of MSISDN number with current serving cell, and
a serving MSC for controlling cells represented by groups of base transceiver stations (BTS) located at fixed geographical locations providing mobility management for mobile stations.

10. A system according to claim 9, characterised in that the CCC (40) is connected to a LBAS Service (50) that is connected to an interface for managing and controlling the system, and where the interface is used for selecting type of alert message and the geographical area to where the messages are to be sent.

11. A system according to claim 9, characterised in that the CCC (40) comprises means for converting information of a specific geographical area to cell ids, including a database (45) with information on which area each cell is covering, and screening means for selecting only cells that are located in the relevant geographical area, and means for providing this information to the MDC (30).

12. A system according to claim 9, characterised in that the LBAS db (25) is connected to a probe (20) for monitoring the traffic between a mobile switch centre (MSC) and a visitor location register (VLR) residing within the network holding current details about subscribers and equipment used.

13. A system according to claim 9, characterised in that the MDC (30) comprises a database (35) for temporary storing of cell id, and means for randomizing the cell ids.

14. A system according to claim 9, characterised in that the MDC (30) comprises means for measuring time elapsed from sending an alert message to a cell to receiving a confirmation from the cell, and means for determining if the time elapsed is above a certain limit, and means for reducing the load of the current cell by sending the alert message to another cell.
